(19) United States
(12) Patent Application Publication
(10) Pub. No.: US 2024/0056829 A1
(43) Pub. Date: Feb. 15, 2024

(54) CONTROL METHOD FOR MOBILE TERMINAL, STORAGE MEDIUM, AND MOBILE TERMINAL

(71) Applicant: HUIZHOU TCL MOBILE COMMUNICATION CO., LTD., Huizhou, Guangdong (CN)

(72) Inventor: Dapeng WANG, Huizhou, Guangdong (CN)

(73) Assignee: HUIZHOU TCL MOBILE COMMUNICATION CO., LTD., Huizhou, Guangdong (CN)

(21) Appl. No.: 18/260,479

(22) PCT Filed: Feb. 7, 2021
(86) PCT No.: PCT/CN2021/075865

§ 371 Date: Jul. 6, 2023

(30) Foreign Application Priority Data
Jan. 7, 2021 (CN) 202110019120.6

(51) Int. Cl. H04W 16/14; H04B 17/318; H04B 17/382

(52) U.S. Cl. CPC H04W 16/14; H04B 17/318; H04B 17/382

(57) ABSTRACT

The present disclosure provides a control method for a mobile terminal, a storage medium, and a mobile terminal. The control method for a mobile terminal specifically comprises: according to a global positioning system starting instruction, acquiring the network signal strength of each of several candidate network frequency bands; according to a reference network frequency band and the acquired network signal strength, determining a target network frequency band corresponding to the mobile terminal, and controlling the mobile terminal to be registered in the target network frequency band. In the present disclosure, after the global positioning system starting instruction is acquired, according to the network signal strength of each network frequency band among several candidate network frequency bands which can be registered, and a reference network frequency band, a registration network frequency band corresponding to the mobile terminal is determined.

### CROSS REFERENCE

This application claims the priority of Chinese Patent Application No. 2021100191206, entitled “CONTROL METHOD FOR MOBILE TERMINAL, STORAGE MEDIUM, AND MOBILE TERMINAL”, filed on Jan. 7, 2020, the disclosure of which is incorporated herein by reference in its entirety.

### FIELD OF THE DISCLOSURE

The present disclosure relates to a mobile terminal technology, and more particularly, to a control method of a mobile terminal, a storage medium and a mobile terminal.

### BACKGROUND

With the rapid development of mobile terminals, more and more mobile terminals are equipped with global positioning systems (GPS). However, when the mobile terminal activates the GPS, the working frequency band used by the GPS will interfere with parts of the network frequency band of a Long-Term Evolution (LTE) network used by the mobile terminal. This will affect the GPS when it searches satellite and captures satellite signals and reduce the performance of the GPS. For example, it might reduce the number of satellites searched by GPS and the stability of satellite signals.

### SUMMARY

One objective of an embodiment of the present disclosure is to provide a control method of a mobile terminal, a storage medium and a mobile terminal to alleviate the above issue.

To solve the technical problems, one embodiment of a first aspect of the present disclosure is directed to a method of controlling a mobile terminal. The method comprises:
according to a global positioning system (GPS) activation instruction, obtaining a network signal strength of each candidate network frequency band in a plurality of candidate network frequency bands, wherein the plurality of candidate network frequency bands do not include a reference network frequency band that conflicts with an operating band of GPS, and the reference network frequency band is a band 13 network frequency band in a Long-Term Evolution (LTE) network;
determining a modified network signal strength corresponding to the reference network frequency band, wherein the modified network signal strength is less than a reference network signal strength corresponding to the reference network frequency band;
selecting the target network frequency band among the plurality of candidate network frequency bands according to the modified network signal strength, wherein the target network signal network strength of the target network frequency band is a maximum network signal strength among obtained network signal strengths, and the target network signal strength is greater than the modified network signal strength;
registering the control mobile terminal in the target network frequency band when the target network frequency band is selected;
when the target network frequency band is not selected, using the reference network frequency band as the target network frequency band and reducing, by lowering a network antenna power of the mobile terminal, a network signal strength of the reference network frequency band to the modified network signal strength.

In one embodiment of the present disclosure, each candidate network frequency band of the plurality of candidate network frequency bands and the reference network frequency band all belong to a working network frequency band of the mobile terminal.

In one embodiment of the present disclosure, the obtaining the network signal strength of each candidate network frequency band in the plurality of candidate network frequency bands according to the GPS activation instruction comprises:
when receiving the GPS activation instruction, detecting whether the mobile terminal is registered in the reference network frequency band; and
when the mobile terminal is registered in the reference network frequency band, obtaining the network signal strength of each candidate network frequency band in the plurality of candidate network frequency bands; and
when the mobile terminal is not registered in the reference network frequency band, activating the GPS.

In one embodiment of the present disclosure, the method further comprises:
when a GPS stop instruction is received, controlling the mobile terminal to register in the reference network frequency band.

In one embodiment of the present disclosure, after using the reference network frequency band as the target network frequency band and reducing, by lowering a network antenna power of the mobile terminal, a network signal strength of the reference network frequency band to the modified network signal strength, the method further comprises:
when a GPS stop instruction is received, recovering the network antenna power of the mobile terminal to recover the network signal strength of the reference network frequency band.

Another embodiment of a second aspect of the present disclosure is directed to a method of controlling a mobile terminal. The method comprises:
according to a global positioning system (GPS) activation instruction, obtaining a network signal strength of each candidate network frequency band in a plurality of candidate network frequency bands, wherein the plurality of candidate network frequency bands do not include a reference network frequency band that conflicts with an operating band of GPS;
according to corresponding network signal strengths of the reference network frequency band and each candidate network frequency band, determining a target network frequency band corresponding to the mobile terminal and controlling the mobile terminal to be registered in the target network frequency band.

In one embodiment of the present disclosure, each candidate network frequency band of the plurality of candidate network frequency bands and the reference network frequency band all belong to a working network frequency band of the mobile terminal.

In one embodiment of the present disclosure, the obtaining the network signal strength of each candidate network frequency band in the plurality of candidate network frequency bands according to the GPS activation instruction comprises:
when receiving the GPS activation instruction, detecting whether the mobile terminal is registered in the reference network frequency band; and
when the mobile terminal is registered in the reference network frequency band, obtaining the network signal strength of each candidate network frequency band in the plurality of candidate network frequency bands.

In one embodiment of the present disclosure, the obtaining the network signal strength of each candidate network frequency band in the plurality of candidate network frequency bands according to the GPS activation instruction further comprises:
when the mobile terminal is not registered in the reference network frequency band, activating the GPS.

In one embodiment of the present disclosure, each candidate network frequency band of the plurality of candidate network frequency bands is a network frequency band in an LTE network, and each candidate network frequency band in the plurality of candidate network frequency bands is different from each other.

In one embodiment of the present disclosure, the mobile terminal stores in advance the network signal strength corresponding to each candidate network frequency band in the plurality of candidate network frequency bands, wherein the network signal strength corresponding to each candidate network frequency band is acquired and recorded by the mobile terminal when the mobile terminal acquires each candidate network frequency band.

In one embodiment of the present disclosure, the determining the target network frequency band corresponding to the mobile terminal according to the corresponding network signal strengths of the reference network frequency band and each candidate network frequency band and controlling the mobile terminal to be registered in the target network frequency band comprises:
determining a modified network signal strength corresponding to the reference network frequency band, wherein the modified network signal strength is less than a reference network signal strength corresponding to the reference network frequency band;
selecting the target network frequency band among the plurality of candidate network frequency bands according to the modified network signal strength, wherein the target network signal network strength of the target network frequency band is a maximum network signal strength among obtained network signal strengths, and the target network signal strength is greater than the modified network signal strength; and
registering the control mobile terminal in the target network frequency band when the target network frequency band is selected.

In one embodiment of the present disclosure, the selecting the target network frequency band among the plurality of candidate network frequency bands according to the modified network signal strength comprises:
comparing the obtained each network signal strength with the modified network signal strength to select at least one candidate network frequency band having a network signal strength greater than the modified network signal strength; and
when the plurality of candidate network frequency bands corresponding to a maximum network signal strength is greater than 1, randomly selecting a candidate network frequency band as the target network frequency band from the number of candidate network frequency bands corresponding to the maximum network signal strength.

In one embodiment of the present disclosure, the method further comprises:
when a GPS stop instruction is received, controlling the mobile terminal to register in the reference network frequency band.

In one embodiment of the present disclosure, the determining a target network frequency band corresponding to the mobile terminal and controlling the mobile terminal to register in the target network frequency band according to the reference network frequency band and the corresponding network signal strength of each candidate network frequency band further comprises:
when the target network frequency band is not selected, using the reference network frequency band as the target network frequency band and reducing a network signal strength of the reference network frequency band to the modified network signal strength.

In one embodiment of the present disclosure, the reducing the network signal strength of the reference network frequency band to the modified network signal strength comprises:
modifying the reference network signal strength by reducing the network signal strength of the reference network frequency band by lowering the network antenna.

In one embodiment of the present disclosure, after the determining a target network frequency band corresponding to the mobile terminal and controlling the mobile terminal to be registered in the target network frequency band, the method further comprises:
when a GPS stop instruction is received, recovering the network signal strength of the reference network frequency band.

Another embodiment of a third aspect of the present disclosure is directed to a control device. The control device comprises:
an obtaining module, configured to obtain a network signal strength of each candidate network frequency band in a plurality of candidate network frequency bands according to a GPS activation instruction, wherein the plurality of candidate network frequency bands do not include a reference network frequency band that conflicts with an operating band of GPS; and
a controlling module, configured to determine a target network frequency band corresponding to the mobile terminal according to corresponding network signal strengths of the reference network frequency band and each candidate network frequency band and control the mobile terminal to be registered in the target network frequency band.

Another embodiment of a fourth aspect of the present disclosure is directed to a computer readable storage medium. The computer readable storage medium stores one or more instructions executable by one or more processors to perform the method as provided in the above embodiments.

Another embodiment of a fifth aspect of the present disclosure is directed to a mobile terminal comprising a processor, a memory storing computer readable instructions executable by the processor, and a bus.

The bus is used for performing a communication between the processor and the memory.

When the computer readable instructions are executed by the processor to perform the method as provided in the above embodiments.

Advantageous effect: In contrast to the conventional art, the present disclosure provides a control method for a mobile terminal, a storage medium and a mobile terminal. A method of controlling a mobile terminal includes according to a global positioning system (GPS) activation instruction, obtaining a network signal strength of each candidate network frequency band in a plurality of candidate network frequency bands, wherein the plurality of candidate network frequency bands do not include a reference network frequency band that conflicts with an operating band of GPS; and according to corresponding network signal strengths of the reference network frequency band and each candidate network frequency band, determining a target network frequency band corresponding to the mobile terminal and controlling the mobile terminal to be registered in the target network frequency band. After obtaining the GPS activation instruction, the present disclosure determines the registered network frequency band corresponding to the mobile terminal according to the network signal strength and reference network frequency band of each network frequency band in a plurality of candidate network frequency bands that can be registered. In this way, by adjusting the registered network frequency band of the mobile terminal, it can prevent the network frequency band used by the mobile terminal from interfering with the working frequency band used by the global positioning system, so as to improve the positioning performance of the GPS. Thus, the method of the present embodiment can alleviate the interference issue between LTE and GPS, raise the performance of the GPS, and optimize the network selection to ensure LTE network performance.

### BRIEF DESCRIPTION OF THE DRAWINGS

In order to more clearly illustrate the embodiments of the present disclosure or related art, the following figures will be described in the embodiments are briefly introduced. It is obvious that the drawings are merely some embodiments of the present disclosure, those of ordinary skill in this field can obtain other figures according to these figures without paying the premise.

FIG. 1 is a flow chart of a method of controlling a mobile terminal according to an embodiment of the present disclosure.

FIG. 2 is exemplary flow chart of the method of controlling the mobile terminal according to an embodiment of the present disclosure.

FIG. 3 is a diagram of a control device provided according to an embodiment of the present disclosure.

FIG. 4 is a diagram of the mobile terminal according to an embodiment of the present disclosure.

### DETAILED DESCRIPTION OF PREFERRED EMBODIMENTS

The present disclosure provides a method of controlling a mobile terminal, a storage medium, and a mobile terminal. In order to make the purpose, technical solution, and effect of the present disclosure clearer and clearer, the present disclosure is further described in detail below with reference to the accompanying drawings and examples. It should be understood that the specific embodiments described here are only used to explain the present disclosure, not to limit the present disclosure.

Those skilled in the art will understand that unless otherwise stated, the singular forms “a”, “an”, “said” and “the” used herein may also include plural forms. It should be further understood that the word “comprising” used in the specification of the present disclosure refers to the presence of the stated features, integers, steps, operations, elements and/or components, but does not exclude the presence or addition of one or more other features, Integers, steps, operations, elements, components, and/or groups thereof. It will be understood that when an element is referred to as being “connected” or “coupled” to another element, it can be directly connected or coupled to the other element or intervening elements may also be present. Additionally, “connected” or “coupled” as used herein may include wireless connection or wireless coupling. The expression “and/or” used herein includes all or any elements and all combinations of one or more associated listed items.

Those skilled in the art can understand that, unless otherwise defined, all terms (including technical terms and scientific terms) used herein have the same meaning as commonly understood by those of ordinary skill in the art to which this disclosure belongs. It should also be understood that terms, such as those defined in commonly used dictionaries, should be understood to have meanings consistent with their meaning in the context of the prior art, and unless specifically defined as herein, are not intended to be idealized or overly Formal meaning to explain.

In a specific implementation, the mobile terminals described in the embodiments of the present disclosure include but are not limited to other portable devices such as mobile phones with touch-sensitive surfaces (for example, touch screens and/or touchpads), laptop computers or tablet computers. equipment. It should also be understood that in some embodiments, the device is not a portable communication device, but is a desktop computer with a touch-sensitive surface (e.g., a touchscreen display and/or a touchpad).

In the following discussion, a mobile terminal including a display and a touch-sensitive surface is described. However, it should be understood that a mobile terminal may also include one or more other physical user interface devices such as a physical keyboard, mouse and/or joystick.

The mobile terminal supports various applications, such as one or more of the following: drawing application, presentation application, word processing application, video conferencing application, disk burning application, spreadsheet application, game application, telephone applications, video conferencing applications, e-mail applications, instant messaging applications, exercise support applications, photo management applications, data camera applications, digital video camera applications, web browsing applications, digital music player applications and/or digital video playback applications, etc.

Various applications that can be executed on the mobile terminal can use at least one common physical user interface device, such as a touch-sensitive surface. The first or more functions of the touch-sensitive surface and corresponding information displayed on the terminal can be adjusted and/or changed between applications and/or within a respective application. In this way, the common physical frame of the terminal (eg, touch-sensitive surface) can support various applications with a user interface that is intuitive and transparent to the user.

It should be understood that the sequence numbers and sizes of the steps in this embodiment do not mean the order of execution, and the execution order of each process is determined by its function and internal logic, and should not constitute any limitation to the implementation process of the embodiment of the present disclosure.

With the rapid development of mobile terminals, more and more mobile terminals are equipped with global positioning systems (GPS). However, when the mobile terminal activates the GPS, the working frequency band used by the GPS will interfere with parts of the network frequency band of the LTE network used by the mobile terminal. This will affect the GPS when it searches satellite and captures satellite signals and reduce the performance of the GPS. For example, it might reduce the number of satellites searched by GPS and the stability of satellite signals.

In order to solve the above issue, a conventional solution is to avoid conflicts between the network frequency band used by the mobile terminal and the network frequency band used by GPS when GPS is started. This will reduce the antenna power of the mobile terminal, thereby reducing the interference of the network frequency band used by the GPS to search satellites and capture satellite signals and thus ensuring the accuracy of the GPS positioning. However, this method will reduce the network quality of the mobile terminal, thereby reducing the network performance used by the mobile terminal.

In order to alleviate the above issue, in an embodiment, the present disclosure could obtain a network signal strength of each candidate network frequency band in a plurality of candidate network frequency bands according to the GPS activation instruction, determine a target network frequency band corresponding to the mobile terminal according to a reference network frequency band and the corresponding network signal strength of each candidate network frequency band, and control the mobile terminal to register in the target network frequency band. After obtaining the GPS activation instruction, the present disclosure determines the corresponding registered network frequency band of the mobile terminal according to the network signal strength and reference network frequency band of each network frequency band in a plurality of candidate network frequency bands that can be registered. In this way, by adjusting the registered network frequency band of the mobile terminal, it can prevent the network frequency band used by the mobile terminal from interference with the network frequency band used by the GPS, so as to improve the positioning performance of the GPS.

The embodiments of the present disclosure in conjunction with the accompanying drawings are described below.

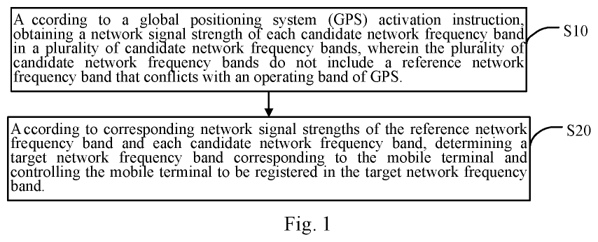

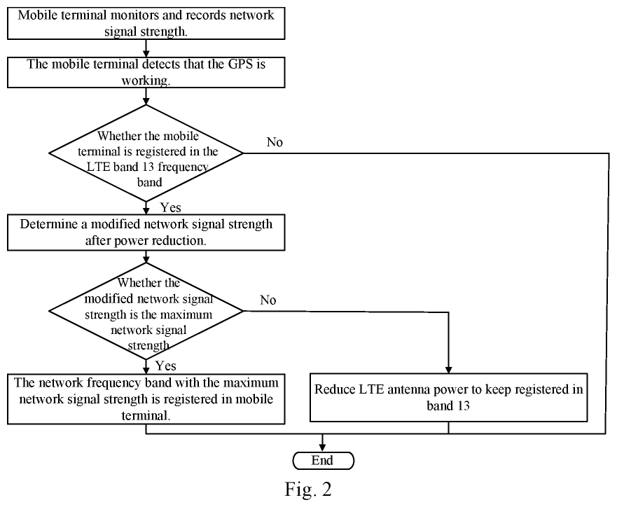

Please refer to FIG. 1 and FIG. 2. A control method for controlling a mobile terminal according to an embodiment of the present disclosure is disclosed. The control method comprises:

S10: according to a GPS activation instruction, obtaining a network signal strength of each candidate network frequency band in a plurality of candidate network frequency bands.

Each network frequency band in the plurality of candidate network frequency bands is a network frequency band that the mobile terminal can register. In other words, the mobile terminal can work in each candidate network frequency band of the candidate network frequency bands. The plurality of candidate network frequency bands do not include any reference network frequency band that conflicts with the working frequency band of the GPS. Here, the reference network frequency band is a network frequency band that the mobile terminal can register, but when the mobile terminal starts the GPS, the working frequency band of the GPS conflicts with the reference network frequency band, thereby affecting the working performance of the GPS.

In an embodiment, the network used by the mobile terminal may be Long Term Evolution (LTE) network, and each candidate network frequency band of the plurality of candidate network frequency bands is a network frequency band in the LTE network. Furthermore, the reference network frequency band is also a network frequency band in the LTE network, and the plurality of candidate network frequency bands and the reference network frequency band are different from each other. Among them, the operating frequency band of the LTE network is 0-4000 MHz, and the operating frequency band of the LTE network is divided into 44 network frequency bands, which are respectively recorded as band 1, band 2, . . . , band 44, where each network frequency band in the plurality of network frequency bands corresponding to the LET network is different from each other. For example, band 1 network frequency band corresponds to 1920 MHz-1980 MHz, band2 network frequency band corresponds to 1850 MHz-1910 MHz, etc.

In an embodiment, when the network used by the mobile terminal is an LTE network, the working frequency band used by the GPS will conflict with the band 13 network frequency band in the LTE network, and the working frequency band used by the GPS will be interfered with by the band 13 network frequency band in the LTE network. Accordingly, the reference network frequency band may be the band 13 network frequency band in the LTE network, each candidate network frequency band of the plurality of candidate network frequency bands is included in a plurality of network frequency bands corresponding to the LTE network, and the plurality of candidate network frequency bands do not include band 13 network frequency band. For example, the plurality of candidate network frequency bands are band 39, band 38, and band 40 in the plurality of network frequency bands corresponding to LTE networks.

In an embodiment, the step S11 could comprise: when receiving the GPS activation instruction, detecting whether the mobile terminal is registered in the reference network frequency band; and if the mobile terminal is registered in the reference network frequency band, obtaining the network signal strength of each candidate network frequency band in the plurality of candidate network frequency bands.

Specifically, the GPS activation instruction may be an activation instruction formed by triggering the control button of the mobile terminal, an activation instruction triggered by a third-party application loaded by the mobile terminal, or an activation instruction triggered by sending a control command through an external device. After receiving the activation instruction, the mobile terminal will activate its own configuration of the GPS based on the activation instruction and will detect whether the mobile terminal is registered in the reference network frequency band. Here, the reference network frequency band is the network frequency band that conflicts with the working frequency band of the GPS.

In an embodiment, the step of detecting whether the mobile terminal is registered in the reference network frequency band refers to determining whether the network frequency band currently used by the mobile terminal will interfere with the GPS, wherein the currently-used network frequency band refers to the network frequency band used by the mobile terminal when the activation instruction is obtained. If the mobile terminal is registered in the reference network frequency band, this means that the network frequency band currently used by the mobile terminal will cause interference to the GPS. In such case, it is necessary to obtain the network signal strength of each candidate network frequency band in the plurality candidate network frequency bands to adjust the network frequency band used by the mobile terminal and avoid interference with the GPS. Conversely, when the mobile terminal is not registered in the reference network frequency band, this indicates that the network frequency band currently used by the mobile terminal will not interfere with the GPS and thus there is no need to adjust the network frequency band used by the mobile terminal, and the GPS is directly activated.

In an embodiment, the plurality of candidate network frequency bands are network frequency bands configured in the LTE network environment. When the mobile terminal receives the activation instruction, the mobile terminal may be registered in each of the candidate network frequency bands. Among them, the network signal strength corresponding to each candidate network frequency band in the plurality of candidate network frequency bands can be stored in advance in the mobile device. When the mobile terminal receives the GPS activation instruction start, it reads the corresponding network signal strength of each candidate network frequency band stored in itself to obtain the network signal strength of each candidate network frequency band in the plurality of candidate network frequency bands. In addition, in the actual implementation, the network signal strength corresponding to each candidate network frequency band can be the network signal strength of each candidate network frequency band obtained by detecting the signal strength of each candidate network frequency band when the mobile terminal receives the activation instruction. In an actual implementation, the network signal strength of each candidate network frequency band is obtained and recorded by the mobile terminal when it obtains the candidate network frequency band. It could be understood that in the process of using the mobile terminal, the mobile terminal will obtain and record the corresponding network information strength of each candidate network frequency band in the current LTE network environment, so that the mobile terminal could quickly determine the network signal strength of each candidate network frequency band when receiving the activation instruction, thereby reducing the time period of interfering with the GPS.

S20: according to the reference network frequency band and the corresponding network signal strength of each candidate network frequency band, determining a target network frequency band corresponding to the mobile terminal and controlling the mobile terminal to register in the target network frequency band.

Specifically, the target network frequency band may be a network frequency band of the reference network frequency band and the plurality of candidate network frequency bands, and the network signal strength corresponding to the target network frequency band is the largest network signal strength in each candidate network frequency band in the plurality of candidate network frequency bands and the predicted network signal strength corresponding to the reference network frequency band. After determining the target network frequency band, the control method controls mobile terminal to be registered in the target network frequency band, so as to use the target network frequency band as the network frequency band used by the mobile terminal. In this way, the control method could prevent the network frequency band used by the mobile terminal from interfering with the GPS and could also make the mobile terminal be registered on the optimal network frequency band to ensure that the mobile terminal is in the optimal network environment without affecting the GPS, thereby avoiding any inconvenience caused by poor network performance.

In an embodiment, the step of determining the target network frequency band corresponding to the mobile terminal according to the corresponding network signal strengths of the reference network frequency band and each candidate network frequency band and controlling the mobile terminal to register in the target network frequency band comprises: determining a modified network signal strength corresponding to the reference network frequency band, wherein the modified network signal strength is less than a reference network signal strength corresponding to the reference network frequency band; selecting the target network frequency band among the plurality of candidate network frequency bands according to the modified network signal strength; controlling the mobile terminal to be registered in the target network frequency band when the target network frequency band is selected; and using the reference network frequency band as the target network frequency band and reducing the network signal strength of the reference network frequency band to the modified network signal strength when the target network frequency band is not selected.

Specifically, the reference network signal strength is the network signal strength corresponding to the reference network frequency band when the GPS activation signal is obtained. The modified network signal strength is the modified network information strength corresponding to the reference network frequency band after the preset GPS is activated. Here, the modified network signal strength is less than the reference network signal strength corresponding to the reference network frequency band. The modified network signal strength could be obtained by modifying the reference network signal strength by reducing the network signal strength of the reference network frequency band by lowering the network antenna. In this embodiment, the modified network signal strength may be pre-set, for limiting the maximum network signal strength corresponding to the reference network frequency band when the GPS is activated and the mobile terminal is registered in the reference network frequency band. Here, the modified network signal strength may be constant, or it may be determined based on the reference signal strength. For example, the modified network signal strength is 80% or 70% of the reference network signal strength, etc.

The target signal network strength of the target network frequency band is the maximum network signal strength in the obtained network signal strengths, and the target network signal strength is greater than the modified network signal strength. Therefore, after the modified network signal strength is obtained, each network signal strength is compared with the modified network signal strength, so as to select those network signal strengths greater than the modified signal strength. Furthermore, the largest network signal strength is used to select the corresponding candidate network frequency band as the target network frequency band. Please note, when there are multiple candidate network frequency bands having the network signal strength greater than the modified network signal strength and the number of candidate network frequency bands corresponding to the maximum network signal strength in the plurality of candidate network frequency bands is greater than 1, one candidate network frequency band corresponding to the maximum network signal strength can be randomly selected as the target network frequency band.

For example, the reference network frequency band is the band 13 band of the LTE network, and the mobile terminal is registered to the band 13 band. The plurality of candidate network frequency bands include a candidate network frequency band A, a candidate network frequency band B, a candidate network frequency band C, and a candidate network frequency band D. The modified network signal strength a corresponding to the band 13 band is compared with the corresponding network signal strengths of the candidate network frequency band A, the candidate network frequency band B, the candidate network frequency band C and the candidate network frequency band D. Here, the network signal strength of the candidate network frequency band A and the network signal strength of candidate network frequency band B are greater than the modified network signal strength a, and the network signal strength of the candidate network frequency band A is greater than the network signal strength of candidate network frequency band B. Accordingly, the candidate network frequency band A is selected as the target network frequency band.

In an embodiment, when the target network frequency band is selected, the mobile terminal is controlled to be registered in the target network frequency band. Conversely, when the target network frequency band is not selected, the reference network frequency band is taken as the target network frequency band, and the network signal strength of the reference network frequency band is reduced to the modified network signal strength. Here, the network signal strength of the reference network frequency band is reduced to the modified network signal strength by adjusting the working frequency of the network antenna to reduce the network signal strength of the reference network frequency band to the modified network signal strength. For example, the reference network band is the band 13 band of the LTE network, and the network signal strength of the band 13 band is reduced to the modified network signal strength when the LTE antenna power is reduced.

In an embodiment, after the mobile terminal is registered in the target network band, the working state of the GPS is monitored. When the GPS stop instruction is obtained, if the target network frequency band registered by the mobile terminal during the GPS operation is not a reference network frequency band, the mobile terminal is controlled to be registered in the reference network frequency band. If the target network band registered by the mobile terminal during the GPS operation is the reference network band, the network signal strength of the reference network frequency band is restored. Here, when the GPS stop instruction is received, it means that the reference network band and the GPS will no longer produce interference, so that the mobile terminal can be controlled to be re-registered in the reference network frequency band or the network signal strength of the reference network frequency band could be adjusted to improve the network quality of the mobile terminal.

When the GPS stops working, if the mobile terminal is registered in a network frequency band other than band 13 band, then the mobile terminal is controlled to switch the network back to the band 13 band. If the mobile terminal retains the registered band 13 band and reduces the LTE antenna power, then the LTE antenna power restore to increase the network signal strength of the band 13 band.

In contrast to the conventional art, the present disclosure provides a control method for a mobile terminal, a storage medium and a mobile terminal. A method of controlling a mobile terminal includes according to a global positioning system (GPS) activation instruction, obtaining a network signal strength of each candidate network frequency band in a plurality of candidate network frequency bands, wherein the plurality of candidate network frequency bands do not include a reference network frequency band that conflicts with an operating band of GPS; and according to corresponding network signal strengths of the reference network frequency band and each candidate network frequency band, determining a target network frequency band corresponding to the mobile terminal and controlling the mobile terminal to be registered in the target network frequency band. After obtaining the GPS activation instruction, the present disclosure determines the registered network frequency band corresponding to the mobile terminal according to the network signal strength and reference network frequency band of each network frequency band in a plurality of candidate network frequency bands that can be registered. In this way, by adjusting the registered network frequency band of the mobile terminal, it can prevent the network frequency band used by the mobile terminal from interfering with the working frequency band used by the global positioning system, so as to improve the positioning performance of the GPS. Thus, the method of the present embodiment can alleviate the interference issue between LTE and GPS, raise the performance of the GPS, and optimize the network selection to ensure LTE network performance.

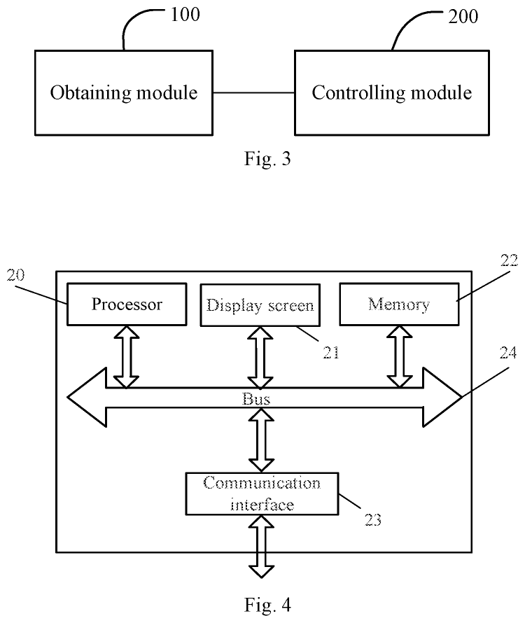

Based on the above-mentioned control method of the mobile terminal, a control device is disclosed according to an embodiment of the present disclosure. As shown in FIG. 3, the control device comprises: an obtaining module 100 and a controlling module 200. The obtaining module 100 is configured to obtain a network signal strength of each candidate network frequency band in a plurality of candidate network frequency bands according to a GPS activation instruction, wherein the plurality of candidate network frequency bands do not include a reference network frequency band that conflicts with an operating band of GPS. The controlling module 200 is configured to determine a target network frequency band corresponding to the mobile terminal according to corresponding network signal strengths of the reference network frequency band and each candidate network frequency band and control the mobile terminal to be registered in the target network frequency band.

Please note that the working process of the control device in this embodiment is the same as the working process of the control method of the mobile terminal described above. Further illustrations are omitted here for simplicity and the working process of the control device could be referred to the control method of the mobile terminal.

Based on the above-mentioned control method of the mobile terminal, a computer-readable storage medium is disclosed according to an embodiment of the present disclosure. The computer-readable storage medium stores one or more programs. The one or more programs may be executed by one or more processors to perform the steps in the control method of the mobile terminal as described in the above embodiments.

Based on the above-mentioned control method, a mobile terminal is disclosed according to an embodiment of the present disclosure. As shown in FIG. 4, the mobile terminal comprises at least one processor 20, a display screen 21, and a memory 22. In addition, the mobile terminal may also include a communication interface 23 and a bus 24. The processor 20, the display screen 21, the memory 22 and the communication interface 23 may communicate with each other via the bus 24. The display screen 21 is set to display the preset user interface in the initial setup mode. The communication interface 23 may transmit information. The processor 20 may load the logic instructions in the memory 22 to execute the control method described in the above embodiments.

In addition, the above-mentioned logic instructions in the memory 22 may be implemented in the form of software functional units and when sold or used as an independent product, may be stored in a computer-readable storage medium.

As a computer-readable storage medium, the memory 22 can be configured to store software programs and computer-executable programs, such as program instructions or modules corresponding to the methods in the embodiments of the present disclosure. The processor 20 runs software programs, instructions or modules stored in the memory 22 to execute functional applications and data processing, to implement the methods in the above-mentioned embodiments.

The memory 22 may include a program storage area and a data storage area, wherein the program storage area may store an operating system and an application program required by at least one function; the data storage area may store data created according to the use of the mobile terminal and the like. In addition, the memory 22 may include a high-speed random access memory, and may also include a non-volatile memory. For example, Ii disk, mobile hard disk, read-only memory (ROM), random access memory (RAM), magnetic disk or optical disk and other media that can store program instructions can also be temporary state storage medium.

In addition, the specific process of loading and executing multiple instruction processors in the above storage medium and the mobile terminal has been described in detail in the above method, and will not be described one by one here.

Above are embodiments of the present disclosure, which does not limit the scope of the present disclosure. Any modifications, equivalent replacements or improvements within the spirit and principles of the embodiment described above should be covered by the protected scope of the disclosure.

1. A method of controlling a mobile terminal, comprising:
according to a global positioning system (GPS) activation instruction, obtaining a network signal strength of each candidate network frequency band in a plurality of candidate network frequency bands, wherein the plurality of candidate network frequency bands do not include a reference network frequency band that conflicts with an operating band of GPS, and the reference network frequency band is a band 13 network frequency band in a Long-Term Evolution (LTE) network;
determining a modified network signal strength corresponding to the reference network frequency band, wherein the modified network signal strength is less than a reference network signal strength corresponding to the reference network frequency band;
selecting the target network frequency band among the plurality of candidate network frequency bands according to the modified network signal strength, wherein the target network signal network strength of the target network frequency band is a maximum network signal strength among obtained network signal strengths, and the target network signal strength is greater than the modified network signal strength;
registering the control mobile terminal in the target network frequency band when the target network frequency band is selected; and
when the target network frequency band is not selected, using the reference network frequency band as the target network frequency band and reducing, by lowering a network antenna power of the mobile terminal, a network signal strength of the reference network frequency band to the modified network signal strength.

2. The method of claim 1, wherein each candidate network frequency band of the plurality of candidate network frequency bands and the reference network frequency band all belong to a working network frequency band of the mobile terminal.

3. The method of claim 1, wherein the obtaining the network signal strength of each candidate network frequency band in the plurality of candidate network frequency bands according to the GPS activation instruction comprises:
when receiving the GPS activation instruction, detecting whether the mobile terminal is registered in the reference network frequency band; and
when the mobile terminal is registered in the reference network frequency band, obtaining the network signal strength of each candidate network frequency band in the plurality of candidate network frequency bands; and
when the mobile terminal is not registered in the reference network frequency band, activating the GPS.

4. The method of claim 1, further comprising:
when a GPS stop instruction is received, controlling the mobile terminal to register in the reference network frequency band.

5. The method of claim 1, wherein after using the reference network frequency band as the target network frequency band and reducing, by lowering a network antenna power of the mobile terminal, a network signal strength of the reference network frequency band to the modified network signal strength, the method further comprises:
when a GPS stop instruction is received, recovering the network antenna power of the mobile terminal to recover the network signal strength of the reference network frequency band.

6. A method of controlling a mobile terminal, comprising:
according to a global positioning system (GPS) activation instruction, obtaining a network signal strength of each candidate network frequency band in a plurality of candidate network frequency bands, wherein the plurality of candidate network frequency bands do not include a reference network frequency band that conflicts with an operating band of GPS; and
according to corresponding network signal strengths of the reference network frequency band and each candidate network frequency band, determining a target network frequency band corresponding to the mobile terminal and controlling the mobile terminal to be registered in the target network frequency band.

7. The method of claim 6, wherein each candidate network frequency band of the plurality of candidate network frequency bands and the reference network frequency band all belong to a working network frequency band of the mobile terminal.

8. The method of claim 6, wherein the obtaining the network signal strength of each candidate network frequency band in the plurality of candidate network frequency bands according to the GPS activation instruction comprises:
when receiving the GPS activation instruction, detecting whether the mobile terminal is registered in the reference network frequency band; and
when the mobile terminal is registered in the reference network frequency band, obtaining the network signal strength of each candidate network frequency band in the plurality of candidate network frequency bands.

9. The method of claim 8, wherein the obtaining the network signal strength of each candidate network frequency band in the plurality of candidate network frequency bands according to the GPS activation instruction further comprises:
when the mobile terminal is not registered in the reference network frequency band, activating the GPS.

10. The method of claim 6, wherein each candidate network frequency band of the plurality of candidate network frequency bands is a network frequency band in an LTE network, and each candidate network frequency band in the plurality of candidate network frequency bands is different from each other.

11. The method of claim 6, wherein the mobile terminal stores in advance the network signal strength corresponding to each candidate network frequency band in the plurality of candidate network frequency bands, wherein the network signal strength corresponding to each candidate network frequency band is acquired and recorded by the mobile terminal when the mobile terminal acquires each candidate network frequency band.

12. The method of claim 6, wherein the determining the target network frequency band corresponding to the mobile terminal according to the corresponding network signal strengths of the reference network frequency band and each candidate network frequency band and controlling the mobile terminal to be registered in the target network frequency band comprises:
determining a modified network signal strength corresponding to the reference network frequency band, wherein the modified network signal strength is less than a reference network signal strength corresponding to the reference network frequency band;
selecting the target network frequency band among the plurality of candidate network frequency bands according to the modified network signal strength, wherein the target network signal network strength of the target network frequency band is a maximum network signal strength among obtained network signal strengths, and the target network signal strength is greater than the modified network signal strength; and
registering the control mobile terminal in the target network frequency band when the target network frequency band is selected.

13. The method of claim 12, wherein the selecting the target network frequency band among the plurality of candidate network frequency bands according to the modified network signal strength comprises:
comparing the obtained each network signal strength with the modified network signal strength to select at least one candidate network frequency band having a network signal strength greater than the modified network signal strength; and
when the plurality of candidate network frequency bands corresponding to a maximum network signal strength is greater than 1, randomly selecting a candidate network frequency band as the target network frequency band from the number of candidate network frequency bands corresponding to the maximum network signal strength.

14. The method of claim 12, further comprising:
when a GPS stop instruction is received, controlling the mobile terminal to register in the reference network frequency band.

15. The method of claim 12, wherein the determining a target network frequency band corresponding to the mobile terminal and controlling the mobile terminal to register in the target network frequency band according to the reference network frequency band and the corresponding network signal strength of each candidate network frequency band further comprises:
when the target network frequency band is not selected, using the reference network frequency band as the target network frequency band and reducing a network signal strength of the reference network frequency band to the modified network signal strength.

16. The method of claim 15, wherein the reducing the network signal strength of the reference network frequency band to the modified network signal strength comprises:
modifying the reference network signal strength by reducing the network signal strength of the reference network frequency band by lowering the network antenna.

17. The method of claim 15, wherein after the determining a target network frequency band corresponding to the mobile terminal and controlling the mobile terminal to be registered in the target network frequency band, the method further comprises:
when a GPS stop instruction is received, recovering the network signal strength of the reference network frequency band.

18-19. (canceled)

20. A mobile terminal comprising a processor, a memory storing computer readable instructions executable by the processor, and a bus for performing a communication between the processor and the memory;
when the computer readable instructions are executed by the processor to perform operations comprising:
according to a global positioning system (GPS) activation instruction, obtaining a network signal strength of each candidate network frequency band in a plurality of candidate network frequency bands, wherein the plurality of candidate network frequency bands do not include a reference network frequency band that conflicts with an operating band of GPS; and
according to corresponding network signal strengths of the reference network frequency band and each candidate network frequency band, determining a target network frequency band corresponding to the mobile terminal and controlling the mobile terminal to be registered in the target network frequency band.

21. The mobile terminal of claim 20, wherein each candidate network frequency band of the plurality of candidate network frequency bands and the reference network frequency band all belong to a working network frequency band of the mobile terminal.

22. The mobile terminal of claim 20, wherein the obtaining the network signal strength of each candidate network frequency band in the plurality of candidate network frequency bands according to the GPS activation instruction comprises:
when receiving the GPS activation instruction, detecting whether the mobile terminal is registered in the reference network frequency band; and
when the mobile terminal is registered in the reference network frequency band, obtaining the network signal strength of each candidate network frequency band in the plurality of candidate network frequency bands.
